(19) United States
(12) Patent Application Publication
(10) Pub. No.: US 2002/0103929 A1
(43) Pub. Date: Aug. 1, 2002

(54) Message routing in case multiple network subscription

(75) Inventor: Valeria Molnar, Budapest (HU)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/000,774

(22) Filed: Nov. 30, 2001

Related U.S. Application Data
(63) Continuation of application No. PCT/EP99/03803, filed on Jun. 1, 1999.

(51) Int. Cl. G06F 15/173; H04Q 7/20; H04Q 1/30; G08B 5/22; H04Q 7/00

(52) U.S. Cl. 709/239; 455/466; 370/328; 340/7.2

(57) ABSTRACT

A method and device route a message from an origin (1, 1A, 1B) to a destination (5) adapted to have a subscription to plural networks (GPRS-NW, GSM-NW), wherein the device carries out the method, comprising the steps of: determining (S21) whether the destination (5) has a multiple network subscription; selecting (S24) a route for the message through the multiple networks (GSM-NW, GPRS-NW) if the destination (5) has a multiple network subscription; and transferring (S25) the message from the origin to the destination via the selected route, wherein the selected route is selected dependent on a value of a route indicator (ROUT_IND).

### CROSS-REFERENCE TO RELATED APPLICATION

This application is a continuation of International Application PCT/EP99/03803 having an international filing date of Jun. 1, 1999 and from which priority is claimed under all applicable sections of Title 35 of the United States Code including, but not limited to, Sections 120, 363 and 365(c).

### FIELD OF THE INVENTION

The present invention relates to a method for routing a message from an origin to a destination, said destination being adapted to have a subscription to plural networks adapted to transmit messages. Also, the present invention concerns a corresponding message routing device.

### BACKGROUND OF THE INVENTION

Recently, telecommunication networks as well as the terminals operated in such networks have made considerable progress. For example, apart from the functional feature of (mainly) transmitting speech data (real-time data) via a so-called (well known) GSM network, there is now the possibility to transmit (non-speech) data such as data files (non-real-time data) in a packetized manner via a so-called GPRS network (GPRS=General Packet Radio Service).

Furthermore, some kind of data messages such as the so-called Short Message Service (SMS) can rely on both of the above mentioned networks for transmitting messages.

Thus, with an existing plurality of networks via which transmission of messages, particularly SMS messages, for example, can be effected, the terminal devices for such networks become also adapted to be operated in connection with the corresponding plurality of available networks adapted to transmit messages.

Herein above, the GMS and GPRS networks have been referred to as examples, and the following description will make reference to these two networks. However, it should be noted that the description can easily be expanded to other network types as well as to a different number of networks exceeding two networks.

FIG. 1 of the drawings shows a simplified block diagram for explaining a situation, in which a message is to be routed from an origin to a destination being adapted to have a subscription to plural networks adapted to transmit messages.

As shown in FIG. 1 a message such as a SMS message is generated at an origin 1. The origin 1 can be assumed to comprise a so-called Short Message Entity (SME) denoted by numeral 1A and a Service Center (SC) denoted by numeral 1B.

The generated message to be forwarded to a destination 5 such as a (user) terminal device in form of a mobile station MS is firstly forwarded to a network control element 2 such as a SMS-GMSC (Short Message Service-Gateway Mobile Switching Center) common to the plurality of networks the destination has possibly subscribed to. (Note that the SMS-GMSC mentioned here can be considered to have partly a SMSC (Short Message Service Center) (not shown) functionality, considering that normally a SMSC is connected via a MAP (Mobile Application Part) connection toward a VMSC and has a gateway function.)

Upon receipt of a message to be forwarded to the destination 5, the SMS-GMSC 2 performs a (known) SendRoutingInfoForShortMessage operation with a home location register HLR denoted with numeral 2A or a corresponding functional unit of the network(s).

As a result of this operation, the SMS-GMSC may receive plural addresses, which indicate that the destination 5 has a subscription to plural available network. With reference to the chosen example, two addresses can be retrieved as a result of this operation. Namely, an address indicating a GPRS subscription as well as an address indicating a GSM subscription can be obtained. Each such address indicates that a message such as a SMS message to be transmitted can be routed to the destination 5 via either the GPRS network GPRS-NW or via the GSM network GSM-NW. In FIG. 1, for simplification of the drawings, the GPRS network is represented by a communication path from the SMS-GMSC 2 via a Serving GPRS Support Node (SGSN) denoted with numeral 3, while the GSM network GSM-NW is represented by a communication path from the SMS-GMSC 2 via a Visited Mobile Switching Center (VMSC) denoted with numeral 4 with an associated visitor location register VLR denoted with numeral 4A or with a corresponding functional unit.

Thus, in a case in which a message can be sent via two different routes due to the presence of two different addresses of a subscriber having a subscription to the two different networks, the routing becomes problematical. Hitherto, this problem has been solved in that a network operator has predefined, for such a case, a routing to be used. In connection with the present example, a message is defined to be firstly always routed via either the GPRS-NW or the GSM-NW.

However, assuming a case, in which a first message is to be routed via a first of the possible routes, e.g., via the GPRS network, i.e., via the SGSN, since this route is normally more efficient in terms of network (radio) resources). Upon receipt of a failure report by the SMS-GMSC from the Serving GPRS Support Node SGSN 3 in this example, indicating that the delivery of the message has failed, the message is resent via a second route (differing from the first route), in the present case via the GSM network, i.e., via the VMSC). Nevertheless, a subsequent message to be transmitted to the same destination 5 such as the same user's mobile station MS, is again routed first via the first route.

Apparently, this previous attempt represents some drawbacks such as a waste of network resources, since messages are not efficiently delivered due to an increased number of unsuccessful delivery attempts.

### SUMMARY OF THE INVENTION

Hence, it is an object of the present invention to provide a method for routing a message from an origin to a destination, said destination being adapted to have a subscription to plural networks adapted to transmit messages, and also to provide a corresponding message routing device, which is free from the above drawbacks.

According to the present invention, this object is achieved by a method for routing a message from an origin to a destination, said destination being adapted to have a subscription to plural networks adapted to transmit messages, said method comprising the steps of determining, whether said destination has a multiple network subscription; selecting a route for said message through said multiple networks, if said destination has a multiple network subscription; and transferring said message from said origin to said destination via said selected route, wherein said selected route is selected dependent on a value of a route indicator.

In addition, this object is achieved by a message routing device for routing a message from an origin to a destination, said destination being adapted to have a subscription to plural networks adapted to transmit messages, said device comprising determination means for determining whether said destination has a multiple network subscription; selection means for selecting a route for said message through said multiple networks, in response to an input from said determination means indicating that said destination has a multiple network subscription; and transfer means for transferring said message from said origin to said destination via said selected route, wherein said selection means is adapted to select said route dependent on a value of a route indicator.

Further refinements of the present invention are as set out in the respective dependent claims.

Consequently, with the present invention, a more efficient delivery of messages is achieved, since unsuccessful attempts for message delivery can be significantly reduced. Also, the resources of the network can be saved with the present invention being implemented, since the best route for a message can be chosen and selected according to the prevailing situation at the destination, i.e., the subscriber terminal.

Thus, the route indicator parameter (on the SMSC-SMS-GMSC interface) can optimize the routing of messages such as SMS messages, can cause an increased success rate for message delivery using the first route at a first attempt, and in consequence, reduces the load in network control devices such as MSCs and on corresponding interfaces.

### BRIEF DESCRIPTION OF THE DRAWINGS

The present invention will now be described with reference to the accompanying drawings, in which:

FIG. 1 shows a simplified block diagram for explaining a situation, in which a message is to be routed from an origin to a destination being adapted to have a subscription to plural networks adapted to transmit messages;

FIG. 2 illustrates the method according to the present invention by means of a flow chart diagram; and

FIG. 3 depicts a block diagram of a message routing device according to the present invention.

### DETAILED DESCRIPTION OF PREFERRED EMBODIMENTS

The present invention will now be described in detail with reference to the drawings.

According to the present invention, a route indicator is set to define another route to be tried first (when subsequently transmitting messages), if a destination such as a user terminal can not be reached via an initially tried route. The route indicator is a parameter set by the SMSC based on a message delivery error such as a MNRR (Mobile station Not Reachable Reason). The MNRR contain detailed reason about an absence of a destination/mobile station, and among others include the following Mobile station Not Reachable Reasons: Absent subscriber with GPRS detach, Absent subscriber with IMSI detach, GPRS connection of subscriber suspended.

For example, the SMSC sends this parameter to the SMS-GMSC, and the parameter indicates which route has to be tried first (for subsequent message transmissions), i.e. via the SGSN or via the VMSC, if the HLR sends two (or more) addresses as an answer to the request of SendRoutingInfoForShortMessage.

Stated in other words, for optimizing the routing of messages, a route indicator parameter ROUTE_IND has been specified at the SMS-GMSC interface. The parameter informs the SMS-GMSC by its value, which is based for example on the GPRS and non-GPRS related Mobile station Not Reachable Reason MNRR which are stored in the SMSC, which route has to be used first. Only in case of an unsuccessful delivery of a message, another route is used and the parameter is set to another value. In the described example, the ROUTE_IND parameter may assume two values indicating either the GPRS-NW route or the GSM-NW route, while, however, more than two values are conceivable in case of more than two subscribed networks are available for a respective destination or mobile station.

For example, in case a GPRS MNRR value (at the SMSC) indicates GPRS detach, then the SMSC has to fill and/or set the route indicator parameter to a value indicating that the SMS-GMSC has to use the route via the VMSC first for subsequently delivering a message.

The invention will now be described in even greater detail.

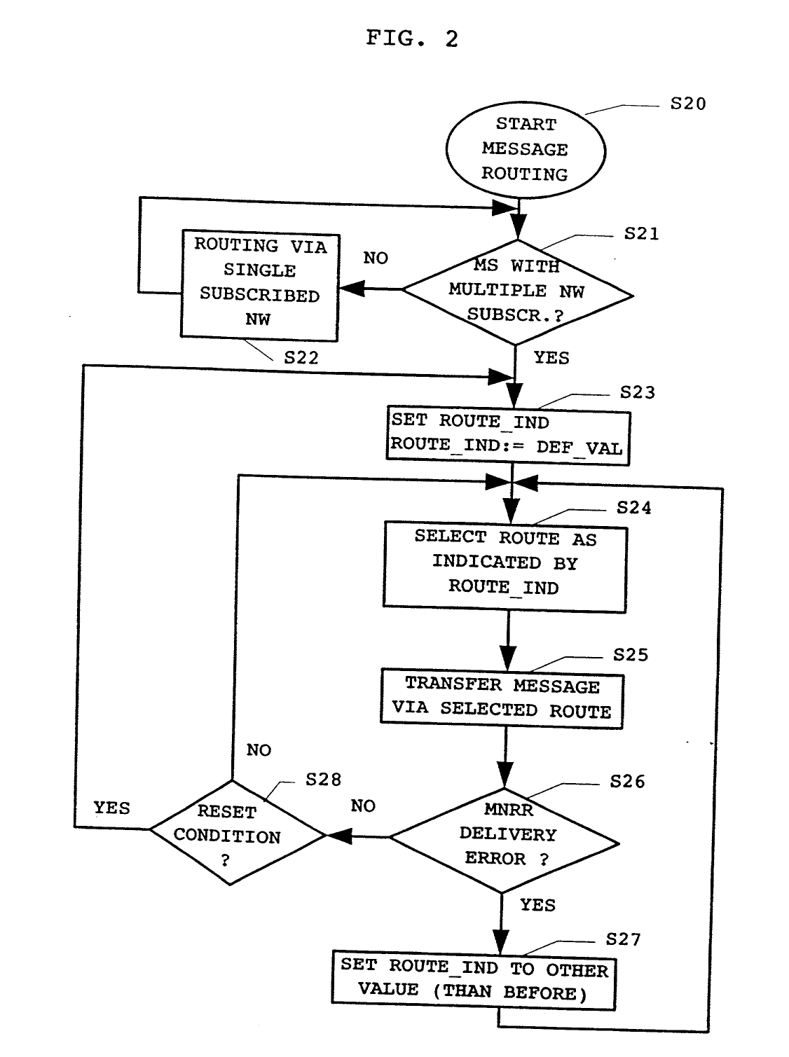

FIG. 2 illustrates the method according to the present invention by means of a flow chart diagram.

The method for routing messages to be transmitted starts in a step S20. In a following step S21 it is checked (from the HLR in a SendRoutingInfoForShortMessage request operation) whether a destination, e.g., the mobile station has a subscription to multiple networks. If the mobile station MS has no multiple subscription but a single subscription only, the routing is effected in step S22 via the single subscribed network, and the flow returns to step S21.

If however, it is determined in step S21 that the mobile station has plural subscriptions (YES in step S21), the flow proceeds to step S23.

In step S23, a route indicator parameter ROUTE_IND is set to a default value. The default value may for example represent the GPRS-NW to be used as a default route in such a case since the GPRS network may be assumed to be more efficient in terms of radio resources.

Thus for a message to be transmitted, in step S24, there is selected a route to be used, which route is indicated by the value of the parameter ROUTE_IND.

Based on the selected route, the message is routed and transferred in step S25 via the selected route.

In a following step S26, it is checked whether a message delivery error such as a MNRR error has been received from the network side (GPRS-NW and/or GSM-NW).

If no such error has been reported (NO in step S26) the flow advances to step S28 to be described later.

If, however, a delivery error is reported from the network side (YES in step S27), this indicates that the destination 5 could not be reached via the selected route, i.e., via the correspondingly selected network.

In response thereto, in step S27, the parameter ROUTE_IND is set to another value than before. This means that if the parameter has beforehand be set to a value indicating “GPRS-NW” as a route to be selected (e.g., as a default value), then the parameter is set in step S27 to a value indicating “GSM-NW” as the network via which the message is to be routed. (other values are conceivable in case more than two subscribed networks are available).

The flow then returns to step S24 and the route to be used is selected based on the value of the parameter ROUTE_IND, and this parameter is maintained valid until a subsequent delivery error is received (which indicates that delivery failed even with this parameter), and the parameter will be changed again.

Unless no deliver error such as MNRR error is received and/or detected in step S26, the flow proceeds via step S28 to either step S23 or step S24, as will be explained later on.

Now, assuming that a message has successfully been routed on the basis of a set parameter ROUTE_IND and a correspondingly selected route, then no MNRR error will be detected in step S26, and the flow will proceed to step S28.

In step S28, it is checked whether a reset condition is present. A reset condition represents a condition indicating that the default value should be reinstated for the route indicator parameter. This could be desirable if the destination becomes reachable again via the network indicated by the default value (e.g. the GPRS-NW). In such a case, the destination (mobile station MS) notifies the home location register HLR of the fact that the mobile station is reachable again via the SGSN with a “ReadyForSM” message. (Similarly, the reset condition may be defined in case the GSM-NW is defined as a default route for messages to be transmitted.)

If no reset condition could be detected, the ROUTE_IND parameter remains unchanged and the flow proceeds to step S24. All subsequent messages transmitted to the specified destination are continuously routed on the basis of the set parameter ROUTE_IND.

If, a reset condition is detected, the flow returns to step S23, and the ROUTE_IND parameter is reset, i.e. set to its default value. This enables still further to always use the optimal routing in terms of a preferred route. (The preferred route should correspond to the default value of the parameter ROUTE_IND.)

It could be noted that the reset condition could also be represented by a counter value being reached. For example, the ROUTE_IND parameter could be automatically reset after a predetermined (counted) time period has lapsed during which a specific parameter has continuously been used. Also, a reset could be initiated after a predetermined number of messages has been transmitted using a specific parameter ROUTE_IND for the routing.

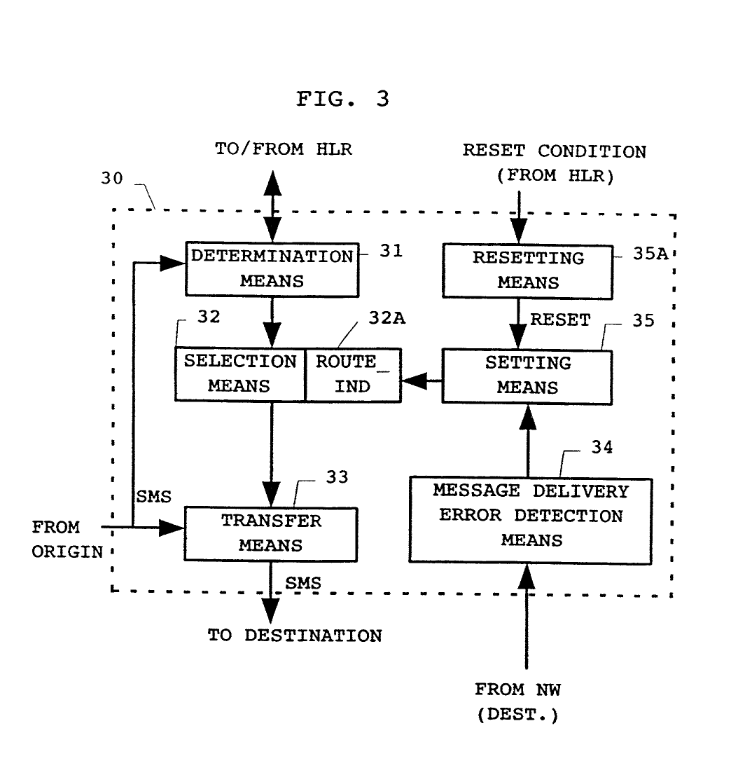

FIG. 3 depicts a block diagram of a message routing device according to the present invention.

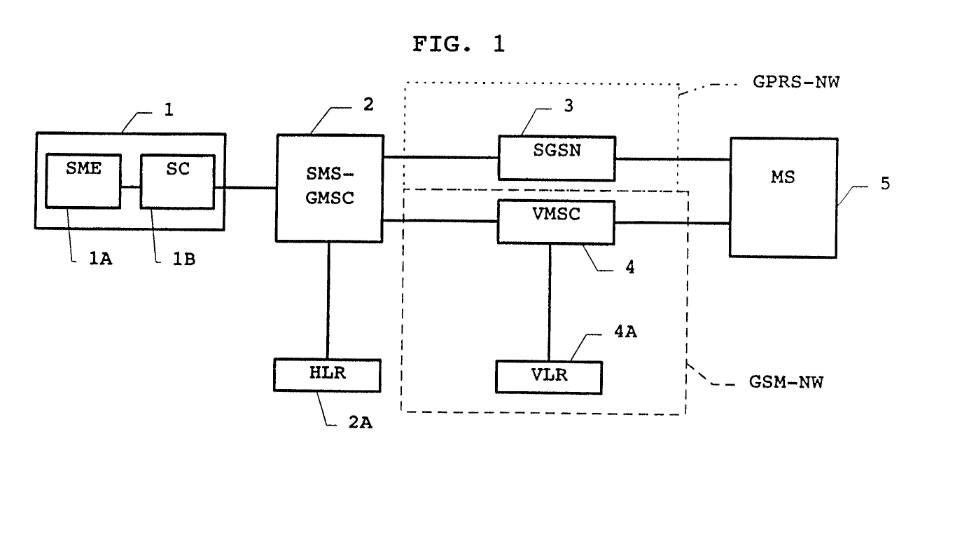

A message such as a SMS message received from an origin (1 in FIG. 1) is supplied to the message routing device 30 (constituting a part of the SMS-GMSC denoted with numeral 2 in FIG. 1). At least an address part of the SMS message is supplied to a determination means 31 of the device. The determination means 31 determines in an interaction with the home location register HLR in a SendRoutingInfoForShortMessage operation, whether the destined destination has a subscription to plural networks or not.

The result thereof is supplied to a selection means 32, to which is associated a memory means 32A in which a record of the current value of the route indicator ROUTE_IND is kept. The selection means 32 is adapted to select a route to be used based on the value of the ROUTE_IND parameter. An information regarding the selected route is forwarded to a transfer means 33, which actually transfers and/or transmits the supplied SMS message to the specified destination.

If, however, such a respective transmission was not successful, the device receives from the network an information, that the destination could not be reached via the intended route (specified by the value of the ROUTE_IND parameter). Such a information is supplied to a message delivery error detection means 34, adapted to detect such transmission errors, particularly to detect such errors as MNRR errors.

In response to such an error detection, the means 34 is adapted to forward an instruction to a setting means 35, instructing the setting means 335 to set the parameter ROUTE_IND to another value. Initially, the parameter ROUTE_IND has been set to a default value such as a value indicating that the GPRS-NW is to be used first for routing messages. Thus, in case of an MNRR error being detected, the setting means sets the value of the ROUTE_IND parameter to a value indicating that the. GSM-NW is to be used for routing, when adhering to the chosen example.

The thus set parameter remains valid, i.e., is maintained unchanged, until a subsequent delivery error is detected, and in response thereto, the value of ROUTE_IND is set again to another value. Nevertheless, the device 30 also comprises resetting means 35A which are adapted to instruct the setting means 35 to reset the value of the ROUTE_IND parameter, i.e., to set the parameter to its default value. The resetting means issue this reset command to the setting means in response to a reset condition being received from the home location register HLR. This reset condition represents a condition indicating that the default value should be reinstated for the route indicator parameter. This could be desirable if the destination becomes reachable again via the network indicated by the default value (e.g., the GPRS-NW). In such a case, the destination (mobile station MS) notifies the home location register HLR of the fact that the mobile station is reachable again via the SGSN with a “ReadyForSM” message, and a corresponding information is forwarded from the home location register to the resetting means 35A.

The functional means of the device according to the present invention have been only briefly explained herein above. However, it is to be understood that the device 30 according to the present invention is adapted to carry out the method according to the present invention as described in connection with FIG. 2.

As has been described herein before, the present invention proposes a method for routing a message from an origin 1, SCE, SC to a destination 5, MS, said destination being adapted to have a subscription to plural networks GPRS-NW, GSM-NW adapted to transmit messages, said method comprising the steps of determining S21, whether said destination MS has a multiple network subscription; selecting S24 a route for said message through said multiple networks GSM-NW, GPRS-NW, if said destination 5, MS has a multiple network subscription; and transferring S25 said message from said origin 1, SME, SC to said destination 5, MS via said selected route, wherein said selected route is selected dependent on a value of a route indicator ROUT_IND.

The present invention also proposes a correspondingly adapted message routing device.

Consequently, according to the present invention, a more efficient delivery of messages is achieved, since unsuccessful attempts for message delivery can be significantly reduced. Also, the resources of the network can be saved with the present invention being implemented, since the best route for a message can be chosen and selected according to the prevailing situation at the destination, i.e., the subscriber terminal. Thus, the route indicator parameter (on the SMSC-SMS-GMSC interface) can optimize the routing of messages such as SMS messages, can cause an increased success rate for message delivery using the first route at a first attempt, and in consequence, reduces the load in network control devices such as MSCs and on corresponding interfaces.

The present invention has been explained with reference to a particular example of a SMS as a message. However, other messages may be routed according to substantially the same method and with a substantially similar device. Moreover, the example has been limited to two subscribed networks, GPRS and GSM. Also this is not limiting, and more than two networks and/or other networks than the mentioned ones could be present, while the present invention could still be applied with only slight modifications being within a skilled person's scope.

Thus, it should be understood that the above description and accompanying figures are merely intended to illustrate the present invention by way of example only. The preferred embodiments of the present invention may thus vary within the scope of the attached claims.

1. A method for routing a message from an origin (1, 1A, 1B) to a destination (5), said destination being adapted to have a subscription to plural networks (GPRS-NW, GSM-NW) adapted to transmit messages, said method comprising the steps of:
determining (S21), whether said destination (5) has a multiple network subscription;
selecting (S24) a route for said message through said multiple networks (GSM-NW, GPRS-NW), if said destination (5) has a multiple network subscription; and
transferring (S25) said message from said origin to said destination via said selected route, wherein
said selected route is selected dependent on a value of a route indicator (ROUT_IND):

2. A method according to claim 1, further comprising a step of setting (S23, S27) the value of said route indicator (ROUT_IND) as a network interface parameter.

3. A method according to claim 1, wherein
said value of said route indicator (ROUT_IND) is dependent on an indication of a delivery error (S26) for a message previously to be routed to said destination.

4. A method according to claim 3, wherein said delivery error represents a Mobile station Not Reachable Reason (MNRR).

5. A method according to claim 3, wherein
said value of said route indicator (ROUT_IND)
maintains a current value in the absence of an indication of a delivery error for a message previously to be routed to said destination (MS), and
is set (S27) to a value differing (SET_VAL) from said current value upon detection (S26) of the presence of a delivery error for a message previously to be routed to said destination.

6. A method according to claim 5, wherein
said route indicator (ROUT_IND) is set (S27), if said delivery error indicates that said destination is not reachable via at least one of said subscribed plural networks (GPRS), to a value representing one other of said plural networks (GSM).

7. A method according to claim 1, wherein
a default value (DEF_VAL) of said route indicator (ROUT_IND) represents a predetermined one (GPRS) of said subscribed plural networks (GPRS, GSM).

8. A method according to claim 4, wherein said Mobile station Not Reachable Reason (MNRR) comprises at least one of the following Mobile station Not Reachable Reasons:
Absent subscriber with GPRS detach
Absent subscriber with IMSI detach
GPRS connection of subscriber suspended.

9. A method according to claim 7, further comprising a step of
resetting (S28, S23) the value of said route indicator (ROUT_IND) to said default value upon receipt of a notification indicating that said predetermined one of said subscribed plural networks is reachable again.

10. A message routing device for routing a message from an origin (1, 1A, 1B) to a destination (5), said destination being adapted to have a subscription to plural networks (GPRS-NW, GSM-NW) adapted to transmit messages, said device comprising:
determination means (31) for determining whether said destination has a multiple network subscription;
selection means (32) for selecting a route for said message (SMS) through said multiple networks (GSM-NW, GPRS-NW), in response to an input from said determination means (31) indicating that said destination (5) has a multiple network subscription; and
transfer means (33) for transferring said message (SMS) from said origin to said destination via said selected route, wherein
said selection means (32) is adapted to select said route dependent on a value of a route indicator (ROUT_IND, 32A).

11. A device according to claim 10, further comprising
setting means (35) for setting the value of said route indicator (ROUT_IND) as a network interface parameter.

12. A device according to claim 10, further comprising
message delivery error detection means (34) adapted to detect a delivery error for a message previously to be routed to said destination, and to supply said detection result to said setting means (35) such that said value of said route indicator (ROUT_IND) is set dependent on said detection result.

13. A device according to claim 12, wherein said delivery error represents a Mobile station Not Reachable Reason (MNRR).

14. A device according to claim 12, wherein
said value of said route indicator (ROUT_IND) maintains a current value in the absence of an indication, by said message delivery error detection means (34), of a delivery error for a message previously to be routed to said destination (MS), and
said setting means (35) is adapted to set said value of said route indicator to a value differing from said current value upon detection, by said message delivery error detection means, of the presence of a delivery error for a message previously to be routed to said destination.

15. A device according to claim 14, wherein said setting means is adapted to set said route indicator (ROUT_IND), if said delivery error indicates that said destination is not reachable via at least one of said subscribed plural networks (GPRS), to a value representing one other of said plural networks (GSM).

16. A device according to claim 10, wherein a default value (DEF_VAL) of said route indicator (ROUT_IND) represents a predetermined one (GPRS) of said subscribed plural networks (GPRS, GSM).

17. A device according to claim 13, wherein said Mobile station Not Reachable Reason (MNRR) comprises at least one of the following Mobile station Not Reachable Reasons:
Absent subscriber with GPRS detach
Absent subscriber with IMSI detach
GPRS connection of subscriber suspended.

18. A device according to claim 16, further comprising
resetting means (35A, 35) adapted to reset the value of said route indicator (ROUT_IND) to said default value upon receipt of a notification indicating that said predetermined one of said subscribed plural networks is reachable again.

19. Method according to claim 2, wherein said value of said route indicator (ROUT_IND) is dependent on an indication of a delivery error (S26) for a message previously to be routed to said destination.

20. A device according to claim 11, further comprising message delivery error detection means (34) adapted to detect a delivery error for a message previously to be routed to said destination, and to supply said detection result to said setting means (35) such that said value of said route indicator (ROUT_IND) is set dependent on said detection result.
